(19) United States
(12) Patent Application Publication
(10) Pub. No.: US 2013/0075563 A1
(43) Pub. Date: Mar. 28, 2013

(54) Suction Disc

(71) Applicants: Yuan-Song Tsai, Tainan City (TW); Sheng-Chi Lin, Tainan City (TW)

(72) Inventors: Yuan-Song Tsai, Tainan City (TW); Sheng-Chi Lin, Tainan City (TW)

(21) Appl. No.: 13/241,488

(22) Filed: Sep. 23, 2011

(51) Int. Cl. F16B 47/00

(52) U.S. Cl. 248/309.3; 248/363

(57) ABSTRACT

A suction disc includes a suction disc body and a coupling body. An inner face of the suction disc body is adapted to be sucked on a supporting surface. The coupling body is extended and formed from an outer face of a central portion of the suction disc body, and a chamber is defined in the coupling body. The suction disc further includes a through-hole extending from the inner face of the suction disc body into the coupling body and in communication with the chamber of the coupling body. After the suction disc is sucked and fixed on the supporting surface, the suction disc can be removed easily by pressing the coupling body.

### BACKGROUND OF THE INVENTION

1. Field of the Invention

The present invention relates to a suction disc and, more particularly, to a suction disc which can provide a better suction effect and can also be easily removed from a supporting surface.

2. Description of the Related Art

A common suction disc is made of a rubber material and can be sucked on supporting surfaces such as walls, tables, etc. In use, face a suction side of the suction disc to a supporting surface, and press a central portion of the suction disc against the supporting surface, so that a near-vacuum state is formed between the suction side of the suction disc and the supporting surface. In this way, the suction disc can be sucked on the supporting surface.

Suction discs are handy devices which can be conveniently and quickly used to suck on supporting surfaces. Therefore, a suction disc is used with many kinds of apparatuses such as hangers to suck on the supporting surfaces. However, conventional suction discs are usually not able to be tightly sucked and fixed on supporting surfaces; furthermore, when the suction discs sucked on the supporting surfaces are needed to be removed, it takes an effort to do it, and it is rather troublesome and inconvenient for users.

### BRIEF SUMMARY OF THE INVENTION

Thus, an objective of the present invention is to provide a suction disc to improve the aforementioned problems. The suction disc can provide a better suction effect for sucking on supporting surfaces such as walls, tables, etc. The suction disc can also be easily removed from the supporting surfaces. Furthermore, the suction disc can be combined with a utensil such as a spoon for convenience of use.

To achieve this and other objectives, a suction disc of the present invention includes a suction disc body and a coupling body. The suction disc body includes inner and outer faces opposed in a thickness direction. The suction disc body further includes a central portion and a circumference extending outwardly from the central portion. The inner face of the suction disc body is adapted for sucking on a supporting surface. The coupling body extends from the outer face of the central portion of the suction disc body in the thickness direction, and a chamber is defined in the coupling body. The suction disc further includes a through-hole extending from the inner face of the suction disc body into the coupling body and being in communication with the chamber of the coupling body. After the suction disc is sucked and fixed on the support surface, the suction disc can be removed easily by pressing the coupling body. Furthermore, air in the chamber can be discharged by pressing the coupling body first, then the inner face of the suction disc body is pressed against the supporting surface, so that the suction disc is tightly sucked and fixed on the supporting surface.

In a preferred form, the coupling body is in the form of a spheroid, and the through-hole extends from the inner face of the central portion of the suction disc body into the coupling body in the thickness direction.

In a preferred form, the coupling body is engaged with a handle to form a utensil such as a spoon. Preferably, the handle of the spoon is made of a hard plastic material, and the coupling body of the suction disc is made of a flexible material and engaged with the handle to form an integrated spoon.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 is a perspective view of a suction disc of the present invention.

FIG. 2 is a cross sectional view of the suction disc of FIG. 1.

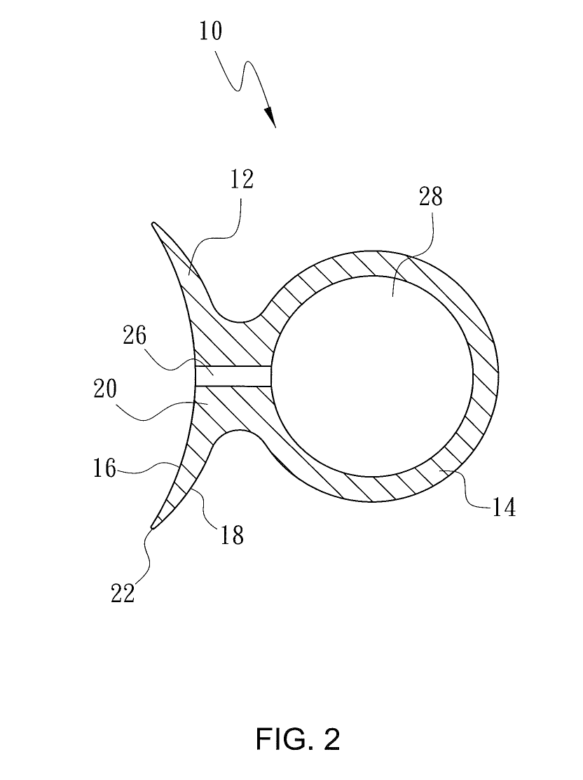

FIG. 3 is an illustration of the suction disc of FIG. 1 being sucked on a supporting surface.

FIG. 4 is an illustration of the suction disc of FIG. 3 being removed from the supporting surface.

FIG. 5 is another illustration of the suction disc of FIG. 1 being sucked on the supporting surface.

FIG. 6 shows a cross sectional view of a suction disc of the present invention being structured as a spoon.

FIG. 7 is a plan view of the spoon of FIG. 6.

### DETAILED DESCRIPTION OF THE INVENTION

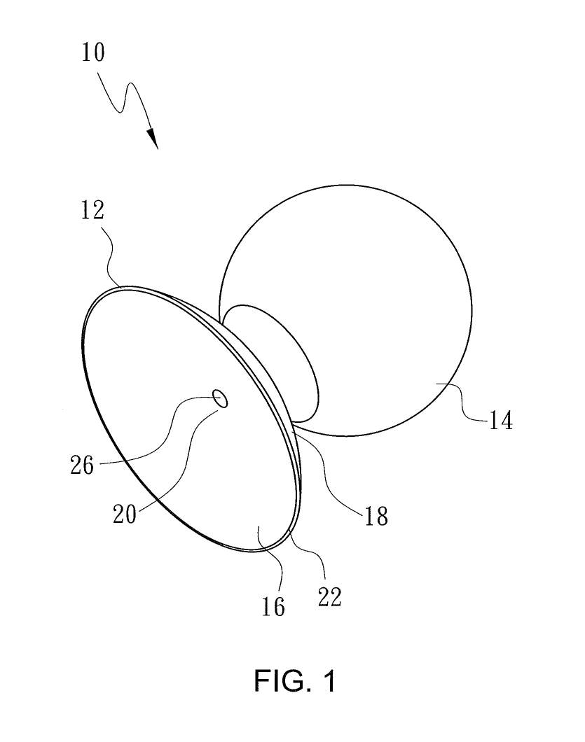

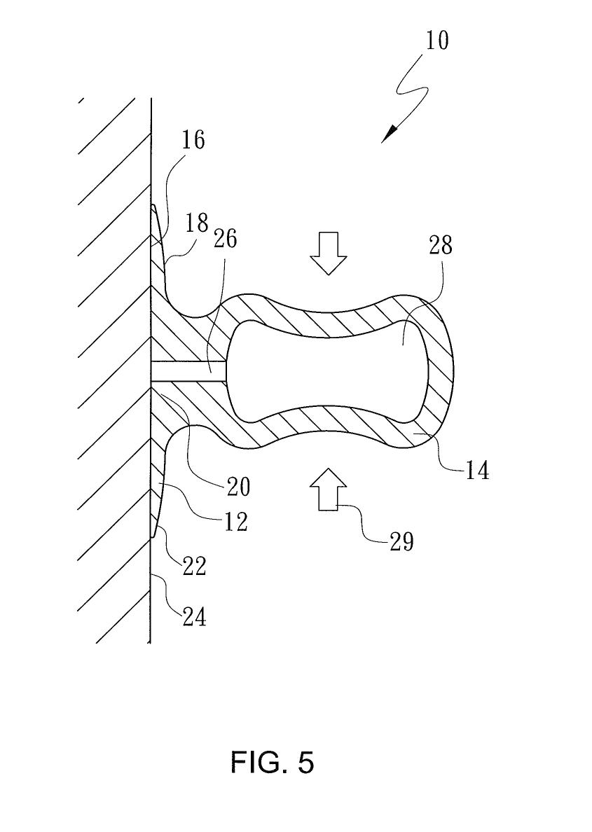

A suction disc of the present invention is shown in FIGS. 1 and 5 of the drawings and generally designated 10. The suction disc 10 is made of a flexible material such as rubber or hard synthetic resin. The suction disc 10 includes a suction disc body 12 and a coupling body 14. The suction disc body 12 is shaped as a round disc and includes inner and outer faces 16 and 18 opposed in a thickness direction. The inner face 16 acts as a suction face for sucking on a supporting surface 24 such as a wall, table, etc. The suction disc body 12 further includes a central portion 20 and a circumference 22 extending outwardly from the central portion 20, such that the inner face 16 is formed in a centrally protruded arc-shape.

The coupling body 14 extends from the outer face 18 of the central portion 20 of the suction disc body 12 in the thickness direction. In this embodiment, the coupling body 14 is shaped as a spheroid, and a chamber 28 is defined therein. However, the coupling body 14 is not limited to be shaped as a spheroid, it can also be in the form of a cylinder.

The suction disc 10 further includes a through-hole 26 extending from the inner face 16 of the central portion 20 of the suction disc body 12 into the coupling body 14. The through-hole 26 is in communication with the chamber 28.

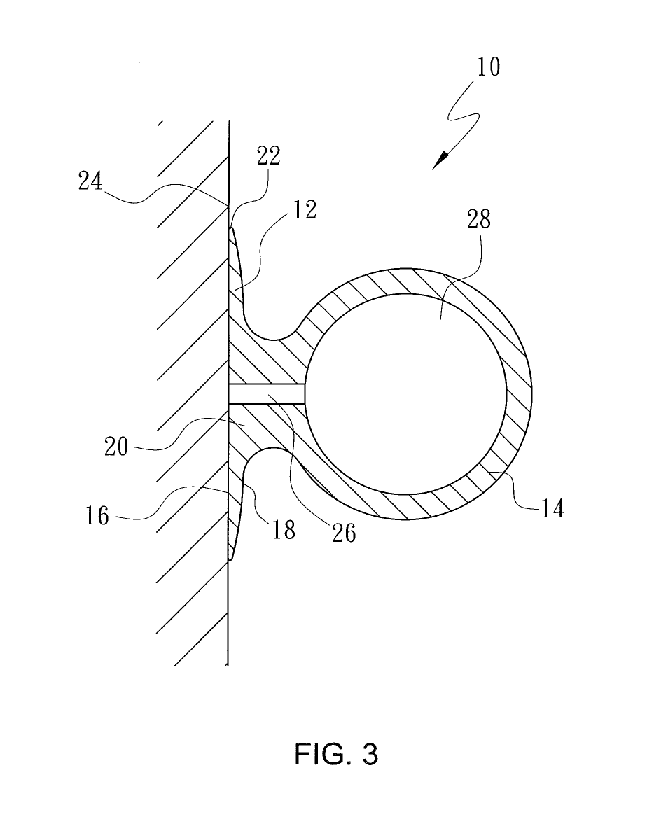

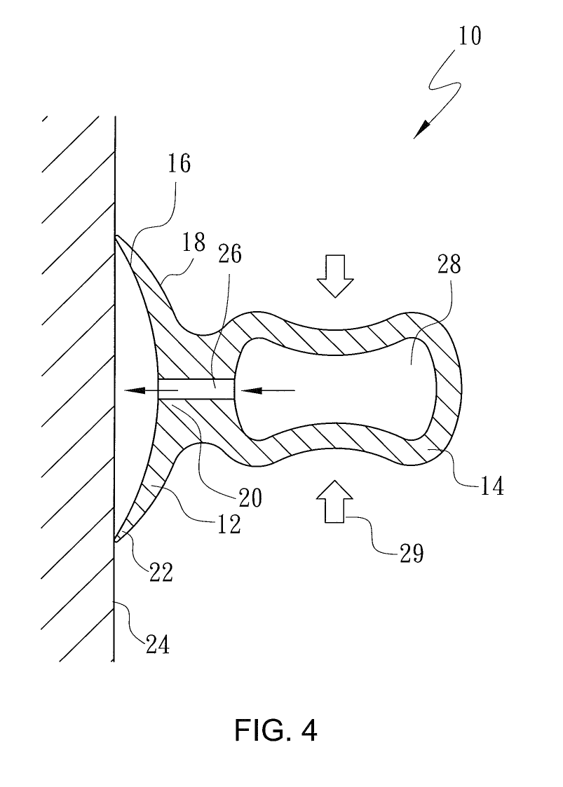

FIG. 3 shows an embodiment of the suction disc 10 being used. In use of suction, the inner face 16 of the suction disc body 12 is pressed against the supporting surface 24 being acted on, so that a near-vacuum state is formed between the inner face 16 and the supporting surface 24. In this way, the suction disc 10 can be sucked and fixed on the supporting surface 24. When the suction disc 10 in FIG. 3 is needed to be removed from the supporting surface 24, press coupling body 14 (as indicated by arrows 29 in FIG. 4), so that air in the chamber 28 flows via the through-hole 26 toward the supporting surface 24 (as indicated by arrows in the chamber 28 in FIG. 4), thus the suction effect of the suction disc body 12 can be eliminated, and the suction disc 10 can be easily removed from the supporting surface 24.

FIG. 5 shows another embodiment of the suction disc 10 being used. In use of suction, the coupling body 14 is pressed to let the air in the chamber 28 to be discharged (as indicated by arrows 29 in FIG. 5), then the inner face 16 of the suction disc body 12 is pressed against the supporting surface 24, so that a near-vacuum state is formed between the inner face 16 and the supporting surface 24. In this way, the suction disc 10 can be tightly sucked and fixed on the supporting surface 24. More specifically, the air in the suction disc body 12 is fully discharged by pressing the coupling body 14, therefore air-tightness of the inner face 16 of the suction disc body 12 being sucked and fixed on the surface 24 can be enhanced effectively. Thus, the suction disc 10 will not easily fall off because of weight, and heavier objects can be hung and supported.

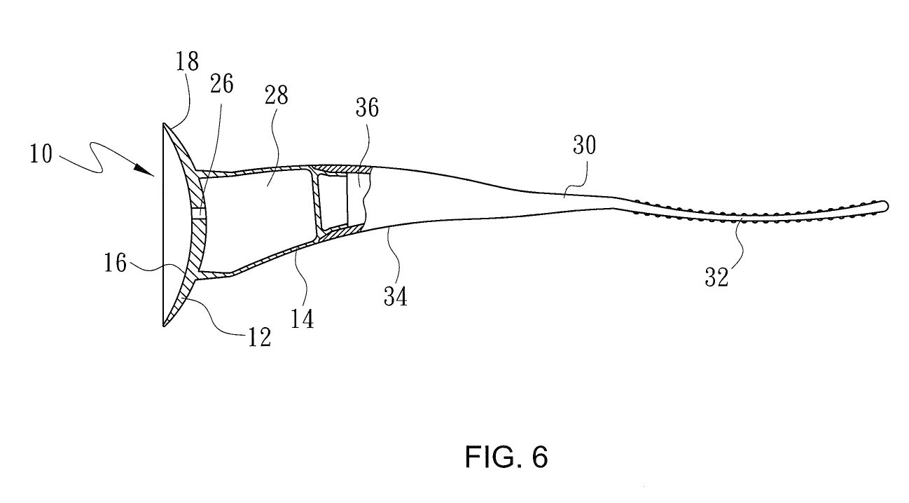

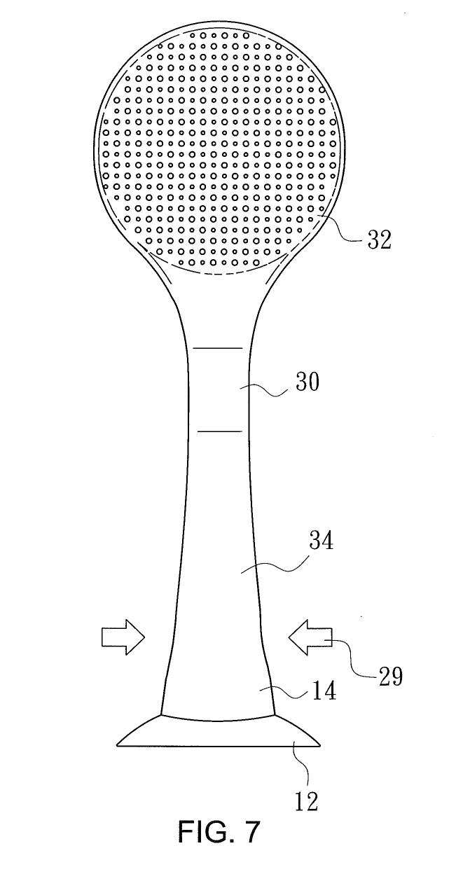

FIGS. 6 and 7 show the suction disc 10 of the present invention being structured as a utensil such as a spoon 30. The spoon 30 is made of a hard plastic material and includes a ladle 32 and a handle 34 with a receiving space 36 in a bottom thereof. In this embodiment, the coupling body 14 is shaped as a cylindrical body, and an upper end of the coupling body 14 is coupled in the receiving space 36, so that the coupling body 14 of the suction disc 10 is integrally combined with the bottom of the handle 34 to form an integrated spoon 30. Alternatively, the coupling body 14 of the suction disc 10 can be detachably coupled with the bottom of the handle 34. When the spoon 30 is needed to be hung up or removed, simply press the flexible coupling body 14 to allow the suction disc 10 to be sucked or removed.

In another feasible embodiment, the coupling body 14 of the suction disc 10 can be engaged with apparatuses such as hangers (not shown in the drawings). Objects can be hung on the hanger after the suction disc body 12 is sucked and fixed on the supporting surface 24.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A suction disc comprising:
a suction disc body including inner and outer faces opposed in a thickness direction, with the suction disc body further including a central portion and a circumference extending outwardly from the central portion, with the inner face of the suction disc body adapted for sucking on a supporting surface;
a coupling body extending from the outer face of the central portion of the suction disc body in the thickness direction, with a chamber defined in the coupling body; and
a through-hole extending from the inner face of the suction disc body into the coupling body and in communication with the chamber of the coupling body, with the chamber having a volume and cross sections greater than the through-hole, with the suction disc body and the coupling body formed of flexible material, with the coupling body being pressable between a normal shape and a collapsed shape, with the volume of the chamber being less in the collapsed shape than in the normal shape.

2. The suction disc according to claim 1, with the coupling body being in the form of a spheroid, with the through-hole extending from the inner face of the central portion of the suction disc body into the coupling body in the thickness direction.

3. The suction disc according to claim 1, with the coupling body engaged with a handle to form a utensil.

4. The suction disc according to claim 3, with the utensil being a spoon, with the handle made of a hard plastic material, and with the coupling body made of the flexible material and engaged with the handle to form an integrated spoon.
